(19) United States
(12) Patent Application Publication
(10) Pub. No.: US 2004/0186769 A1
(43) Pub. Date: Sep. 23, 2004

(54) System and method of modifying the price paid by an advertiser in a search result list

(76) Inventors: Bernard P. Mangold, Pasadena, CA (US); Paul T. Ryan, Pasadena, CA (US)

Correspondence Address: John J. King, BRINKS HOFER GILSON & LIONE, P.O. BOX 10395, CHICAGO, IL, 60610, US

(21) Appl. No.: 10/395,033

(22) Filed: Mar. 21, 2003

(51) Int. Cl. G06F 17/60

(52) U.S. Cl. 705/14

(57) ABSTRACT

The method of the present invention is an improvement on existing internet searches, and particularly paid searching systems such as auction-based commercial search engines. According to the method of the present invention, internet search results are generated based upon the location of the user. An advertiser's rank in a search result list or the amount paid by an advertiser for a click-through is affected by the location of the user and/or the relative distance between the user and the advertiser's physical location. The price that the advertiser will pay in response to the click-through is dependent not only on the amount that the advertiser is prepared to pay, but also on the location of the user, which could be determined by the geographic position of the user or the geographic distance between the advertiser's physical location(s) and the user's location.

### FIELD OF THE INVENTION

The present invention relates generally to internet searching, and more particularly to a method of modifying the price paid by an advertiser in a search result list based upon a location of a user.

### BACKGROUND OF THE INVENTION

Since its inception, the Internet has provided a useful tool for searching for information, products or services. The Internet has also provided a means for enabling the purchase of goods and services, and providing advertisements to a vast population of Internet users. As the access to and the use of the Internet has continued to increase, new uses for the Internet have continued to evolve. One form of advertising has been to allow vendors to bid for a particular position in a search result. That is, an advertiser is ranked according to the cost per click (“CPC”) for each search term. The CPC is the amount the advertiser will pay if a user “clicks through” on the listing. Vendors will be positioned in a search result depending upon their various bids, and will pay the amount of their respective bids in response to a click through by a user. A click through on a listing redirects a user's web browser to the uniform resource locator (URL) associated with the search listing.

However, conventional search tools do not take the location of a user into account in providing search results. More importantly, existing methods and systems for managing the participation in a paid auction do not take into account the location of a user, the geographic distance between the user and an advertiser, and/or the advertiser's physical location. Because certain goods, such as perishable goods or professional services, are important for a local search where the advertiser is interested in attracting the user to visit the physical location of the advertiser rather than just the advertiser's website, the location of the user, the location of the advertiser, and/or the distance between them can be a significant factor in the sale of certain goods. That is, the closer the user is to the advertiser, the more valuable the advertisement is presumed to be.

Accordingly, there is a need for a method affecting the price paid by an advertiser in a search result list based upon the location of a user.

### BRIEF SUMMARY OF THE INVENTION

The method of the present invention is an improvement on existing internet searches, and particularly paid searching systems. According to the method of the present invention, internet search results are altered based upon the location of the user. An advertiser's rank in a search result or the amount paid by an advertiser for a click through is affected by the location of the user. A “click through” of a search result item occurs when the user viewing the search result selects, or “clicks” on the hyperlink of a search result item. In order for a click through to be completed, the searcher's click should be recorded at an account management server and redirected to the advertiser's URL via a redirect mechanism. The price that the advertiser will pay in response to the click through is dependent not only on the amount that the advertiser is prepared to pay (e.g. a minimum bid or the bid amount in a paid auction), but also the location of the user. The location of the user could be determined by the geographic position of the user or the geographic distance between the advertiser's physical location(s) and the user's location. The user's location could be defined by latitude and longitude co-ordinates, zip code, full street address, area code, an Internet protocol (IP) address, a landmark code, etc.

### BRIEF DESCRIPTION OF SEVERAL VIEWS OF THE DRAWINGS

FIG. 1 is a block diagram of a network employing the method for generating a search result list according to the present invention.

FIG. 2 is a block diagram of web pages accessible to advertisers to enable the method for generating a search result list of the present invention.

FIG. 3 is an example of an advertising entry webpage accessible by advertisers to enable an advertiser to enter information according to the present invention.

FIG. 4 is an example of a webpage accessible by a user to perform a search according to the present invention.

FIG. 5 is a diagram showing proximity bands defining the location of a user relative to an advertiser according to the present invention.

FIG. 6 is a diagram showing non-arbitrary regions defining the location of a user according to the present invention.

FIG. 7 is a diagram showing non-arbitrary regions defining the location of a user and defining a distance between an advertiser and a user according to the present invention.

FIG. 8 is a flow chart showing a method of determining rank in an internet search result based upon the distance between an advertiser and a user according to the present invention.

FIG. 9 is a flow chart showing a method of determining rank in an internet search result based upon geographic location of a user according to the present invention.

FIG. 10 is a flow chart showing a method of determining rank in an internet search result based upon distance and the geographic location of a user according to the present invention.

FIG. 11 is a flow chart showing a method of altering a payment for a click through established in an auction based upon the geographic location of a user according to the present invention.

FIG. 12 is a flow chart showing a method of altering a payment for a click through established in an auction based upon the distance between the advertiser and the user according to the present invention.

FIG. 13 is a flow chart showing a method of determining rank and altering payment for a click through established in an auction based upon distance and/or the geographic location of a user according to the present invention.

### DETAILED DESCRIPTION OF THE INVENTION

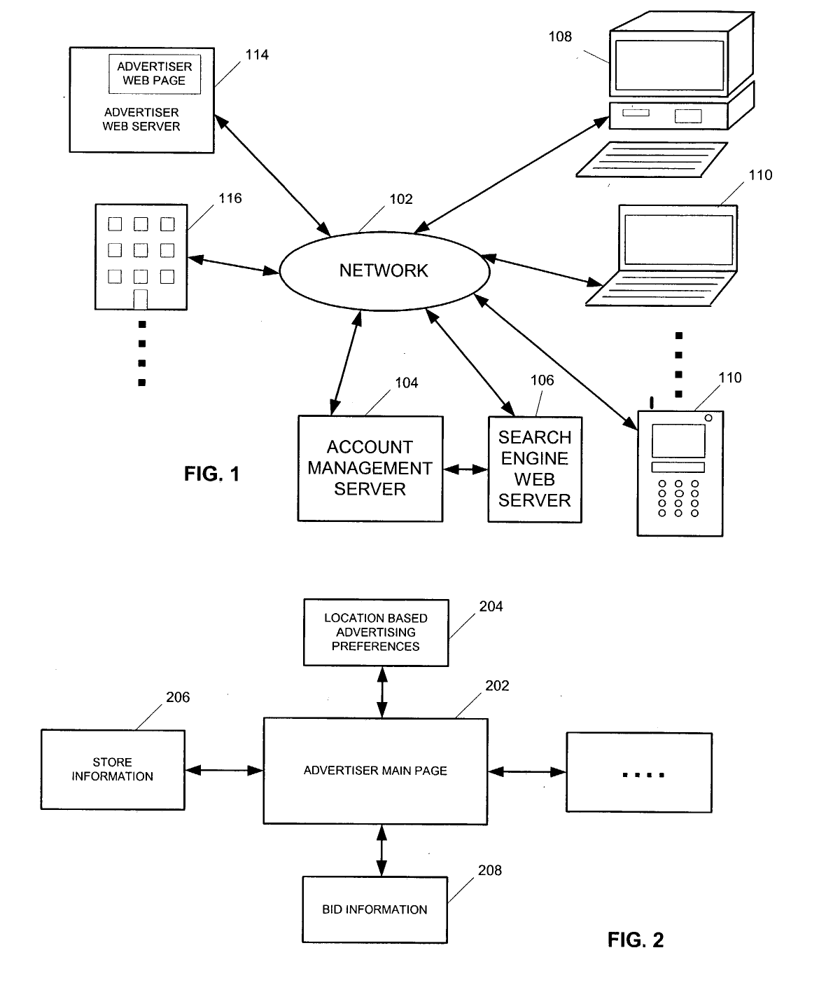

Turning first to FIG. 1, a block diagram of a network employing the method for generating a search result list according to the present invention is shown. A network 102, such as a telecommunications network enabling access to the Internet, is coupled to a number of elements which interact to enable the method of the present invention. In particular, an account management server 104 and a search engine web server 106 enable a user to search the Internet by way of the network 102. The account management server preferably comprises a database having stored therein a plurality of search listing, each search listing being associated with an information provider, at least one keyword, a memory amount, and a computer network location. The operation of the account management server 104 and the search engine web server 106 will be described in more detail reference to remaining figures. Additional information related to the account management server and search engine server, as well as other features of network 102, can be found in U.S. Pat. No. 6,269,361, issued on Jul. 31, 2002 to Davis et al., the entire patent of which is incorporated by reference. A user can search the Internet by way of the search engine web server 106 using a communication device, such as the computer 108, a portable computer 110, or a mobile device 112, such as a cellular telephone, a personal digital assistant (PDA), or some other wireless communication device. Generally, the person conducting an internet search by way of a communication device will be called a user or searcher.

An advertiser's web server 114 enables access to information of the advertiser by way of a communication device employing a search engine. A vendor site 116, which is also shown, may be accessible by the network 102, and generally has a geographic location which is used according to various aspects of the present invention and will be described in more detail in reference to remaining figures. While the vendor site 116 may be associated with the advertiser's web server 114, it should be noted that the vendor site 116 need not have connection to the account management server 104, but can benefit from the features of the present invention. Vendor site 116 could be an individual store having no connection to any of the elements of FIG. 1. For example, the account management server 104 could host a website for the vendor site 116. Therefore, an advertiser could be any vendor providing goods, services, information, etc. from a physical store or online by way of a communication network search on the Internet.

Turning now to FIG. 2, a block diagram shows various web pages accessible to advertisers enabling the method of the present invention. In particular, an advertiser main page 202 enables an advertiser (by way of account management server 104) to enter information related to the advertiser. For example, after entering proper login information on the advertiser main page 202, an advertiser can enter location based advertising preferences on a preferences web page 204. Similarly, an advertiser can enter information related to various stores on a store information web page 206. An advertiser can also enter bid information on a bid information web page 208. While various exemplary web pages are listed in FIG. 2, it will be understood that other web pages available to an advertiser could be employed to enable a vendor to participate in an Internet based search according to the present invention.

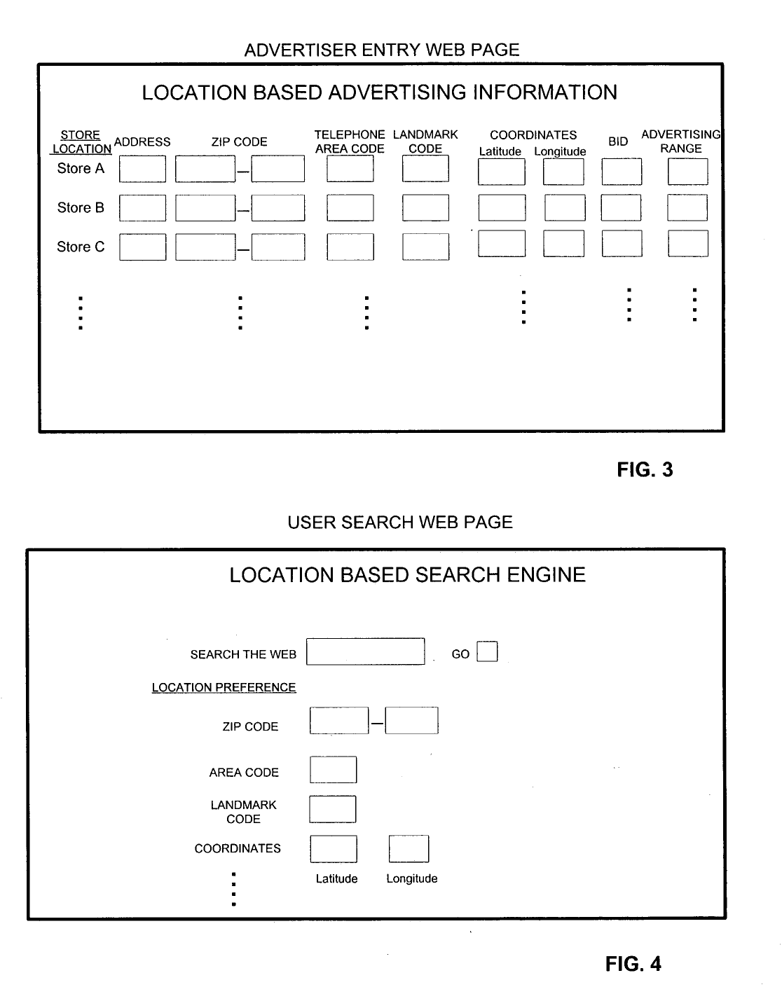

Turning now to FIG. 3, an advertising entry webpage accessible by advertisers enables an advertiser to enter store information according to the present invention. An advertiser can enter information for various stores based on a number of criteria. For example, in addition to the entry of information relating to an address for a particular store, a user can enter a telephone area code, a landmark code (e.g. an airport code), coordinates of the store (e.g. latitude and longitude coordinates), a bid, and an advertising range. The information can be entered in the fields by the advertiser by way of the advertiser's web server 114 accessing the account management server 104, or merely by a vendor providing the information directly to the account management server through an agent of the account management server including automated means for generating advertiser preferences. Such information can be used in connection with a search by user. That is, if information entered by a user in connection with a particular search using a web search engine (such as the web search engine of FIG. 4, for example) corresponds to information provided by the advertiser, the information provided in the search results and or amount paid by the vendor in the event of a click through can be affected, as will be described in reference to the remaining figures.

Turning now to FIG. 4, an example of a webpage accessible by a user to perform a search according to the present invention is shown. In particular, the various fields show in FIG. 4 can be entered by a user by way of one of the communication devices shown in FIG. 1. For example, a user may enter a desire to search a term entered in the “Search the Web” field. A user may also desire to enter certain information relating to the user's location, such as a zip code, area code, landmark code, latitude and longitude, etc. Alternatively, information related to the location of the user could be automatically provided by the communication device. For example, the location of the user can be derived from an IP address as is well known in the art. Alternatively, location information, such as GPS coordinates could be provided by a wireless communication device, or location information could be derived using triangulation techniques in a wireless communication network. Although particular information related to the location of the user is shown in FIG. 3, any other type of information related to location could be employed according to the present invention.

Turning now to FIG. 5, a diagram shows proximity bands defining the location of a user relative to an advertiser according to the present invention. A particular service area can be divided into a plurality of “price bands” such that a first price band (B₁) is defined as a circle (having a radius r₁) centered on the geographic location of advertiser A, the second price band (B₂) is defined as a ring with an inner radius (r₁) and an outer radius (r₂), centered on the geographic location of advertiser A, and a third price band (B₃) is defined as a ring with an inner radius (r₂) and an outer radius (r₃), centered on the geographic location of advertiser A. Although three price bands are shown, any number of price bands could be employed according to the present invention. Similarly, the shape of the price bands need not be concentric circles, but could be any arbitrary polygon.

By defining proximity bands, the relative locations of the advertiser and the user can be used to affect the results of a search. For example, the relative locations could be used to determine the order of research result. Advertisers in closer proximity bands would be positioned higher in an internet search result than those in more distant proximity bands. That is, by knowing that a user is in a certain proximity band, an advertiser would know that a potential buyer is within a certain distance of one of its stores. If the proximity band indicates that the user is a great distance from the store, the advertiser may be less willing to pay a bid amount. Alternatively, the absolute distance d₁ could be used to determine position in the internet search result. Further, the price paid by a user for a click through could be altered depending upon the distance and/or the location of a user in a proximity band. Therefore, the actual amount paid by the advertiser could be reduced from the bid amount depending upon the location in a proximity band, or the absolute distance d₁. Or likewise, depending upon the product, market or service, the actual amount paid by the advertiser could be increased beyond the bid amount depending upon the location in the proximity band, or the absolute distance d₁. Finally, a combination of the order the search results and the price paid, as will be described in more detail in reference to remaining figures could be altered based upon location or distance.

By way of example, suppose that the service area for an advertiser (A) bidding on the term “dentist” is set at 10 miles. Suppose further, that this service area is divided into 3 “price bands” such that the first price band (B₁) is defined as a circle, radius 1 mile, the second price band (B₂) is defined as a ring with an inner radius of 1 mile and an outer radius of 5 miles, and the third price band (B₃) is defined as a ring with an inner radius of 5 miles and an outer radius of 10 miles.

A search conducted by a user for the term “dentist” would yield a search result set that contains a listing by advertiser A if the geographic distance between the user and the location of advertiser A is less than or equal to the service area, 10 miles in this example. The “price band” that the user falls into determines the price that the advertiser will pay. If the geographic distance between the user and the advertiser location is within band B₁, then the advertiser will pay the full amount that the advertiser was willing to pay (i.e. a bid price or some fixed price). If the geographic distance between the user and the advertiser location is within band B₂, then the advertiser will pay some fraction of the bid price as determined by some function ƒ(B₂). According to one embodiment, ƒ(B₂) would halve the bid price for users falling into price band B₂. If the geographic distance between the user and the advertiser location is within band B₁, then the advertiser will pay some other fraction of the bid price as determined by some function ƒ(B₁). For example, ƒ(B₃) would cut the bid price to one quarter for users falling into price band B₂.

According to another embodiment of the present invention, a continuous scale, based on the geographic distance between the advertiser's location and the user, is used to determine the price paid by the advertiser for a “click through”. In this system, some continuous function, ƒ′(d₁), where d₁ is the geographic distance between the user and the advertiser, is used to determine the price paid by the advertiser for a “click through”.

For example, the function describing the price paid could be given by

$${f}^{′} ( D ) = P \times ( 1 - \frac{{d}_{1}}{{r}_{3}} )$$

where P is the bid price, d₁ is the geographic distance between the user and the advertiser's location and r₃ is the service area radius.

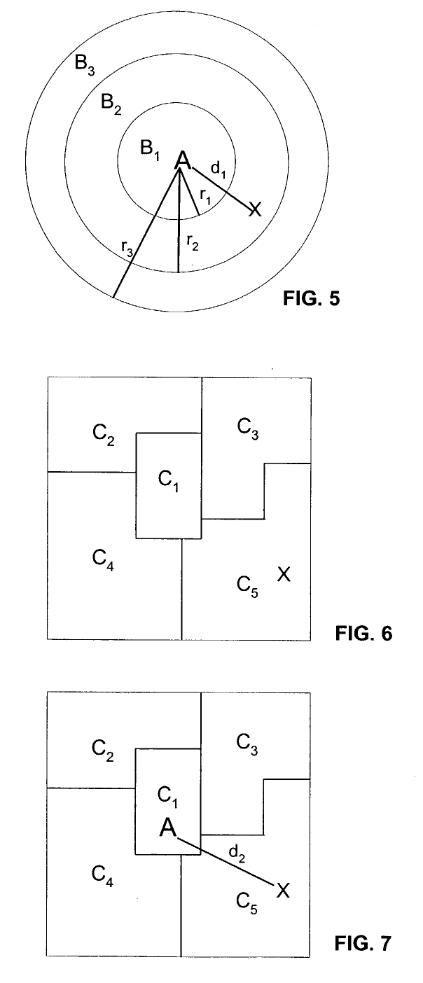

Turning now to FIG. 6, a diagram showing proximity regions comprising non-arbitrary regions according to the present invention is shown. The non-arbitrary regions C₁-C₅ establish boundaries in which a user could be found. The regions could be established by some pre-established boundaries, such as area code, zip code, etc., or could be established by the advertisers based upon purchasing trends or other demographics. According to the alternate embodiment of FIG. 7, in addition to showing non-arbitrary regions, a distance d₂ is also defined according to the present invention. As will be described in more detail in reference to the remaining figures, the relative locations of the advertiser and the user, and distances between them could be used to determine the order of a search result, the price paid by a user for a click through, or a combination of the order the search results and the price paid for a click through. However, it should be understood that factors other than location and distance could be used to determine the order of a search result or the price paid for a click through. Such other factors could include the advertiser's bid, relevance, class, total spending or seniority as well as the relative or absolute historical performance (click-through rate) of the individual listings over time.

In one embodiment of the present invention, the price paid is determined by whether the user and advertiser are in the same zip code or not. In this embodiment, the advertiser will pay the full bid price if the user is in the same zip code (either 5 digit or 3 digit zip code) and some lesser amount if the user is in an adjoining zip code. The price paid continues to lessen the further (as counted in zip code distances) the user is away from the advertiser's location up to the limits of the service area.

Turning now to FIG. 8, a flow chart shows a method of determining rank in an Internet search result based upon geographic location according to the present invention. In particular, an advertiser and is able to store information for location based advertising at a step 802. The information could be, for example, the information shown in FIG. 3. A distance between the advertiser and the searcher is then determined at a step 804. The distance could be determined by an absolute distance, or by a range of distances, such as those defined by the proximity bands of FIG. 5. The rank of the advertiser in a search result is then determined based upon the distance between the advertiser in the user at a step 806. Access to an advertiser's web site is provided in response to inquiry by a searcher at a step 808.

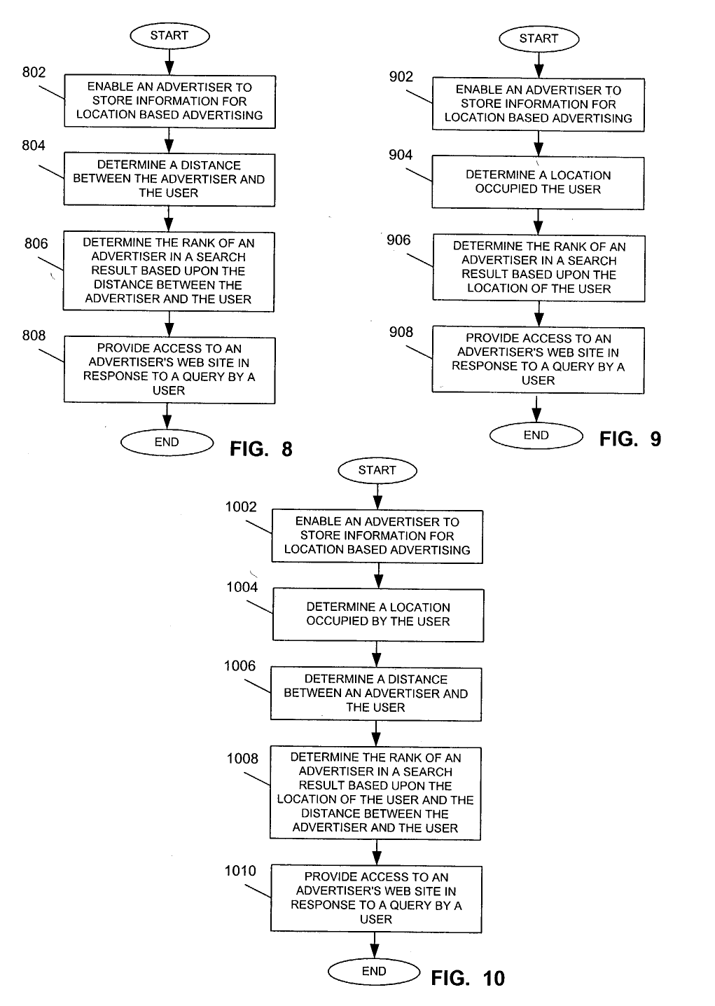

Turning now to FIG. 9, a flow chart shows a method of determining rank in an Internet search result based upon geographic location according to the present invention. An advertiser is able to store information for location based advertising at a step 902. A region occupied by the user is then determined at a step 904. The regions could be those regions shown for example, in FIG. 5 or 6. Finally, the rank of the advertiser in a search result based upon the location of the user is determined at a step 906. Access is provided to the advertiser's web site in response to a query by a user at a step 908.

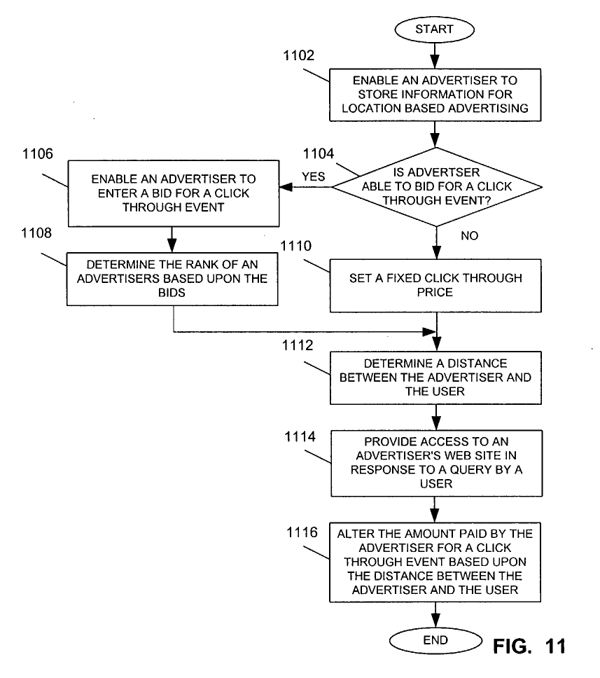

Turning now to FIG. 10, a flow chart shows a method of determining rank and payment reduction based upon distance and/or geographic location according to the present invention. In particular, an advertiser is able to store information for location based advertising at a step 1002. A region occupied by the user is determined at a step 1004. A distance between an advertiser and the user is also determined at a step 1006. Finally, the rank of the advertiser in a search result is determined based upon both the region occupied by the user and the distance between the advertiser and the user at a step 1008. Access is provided to the advertiser's web site in response to inquiry by a user at a step 1010.

Turning now to FIG. 11, a flow chart shows a method of altering a payment established in an auction based upon distance according to the present invention. In particular, an advertiser is able to store information for location based advertising at a step 1102. It is then determined whether the advertiser is able to bid for a click through event at a step 1104. If so, the advertiser is able to enter a bid for a click through at a step 1106. That is, the advertiser can select an amount for which the advertiser will pay the provider of the account management server in the event that a user clicks through to the advertiser's web page. The rank of various advertisers bidding for click through events are then determined at a step 1108. If the advertiser is not allowed to bid for a click through event, a fixed click through price is set at a step 1110.

A distance between the advertiser and the user is then determined at a step 1112. Access is then provided to the advertiser's web site in response to a search by a step 1114. Finally, the amount paid by the advertiser for a click through event is then altered based upon the distance between the advertiser and the user at a step 1116. The amount paid by the advertiser can be reduced as the distance between the advertiser and the user increases, as described in reference to FIG. 5.

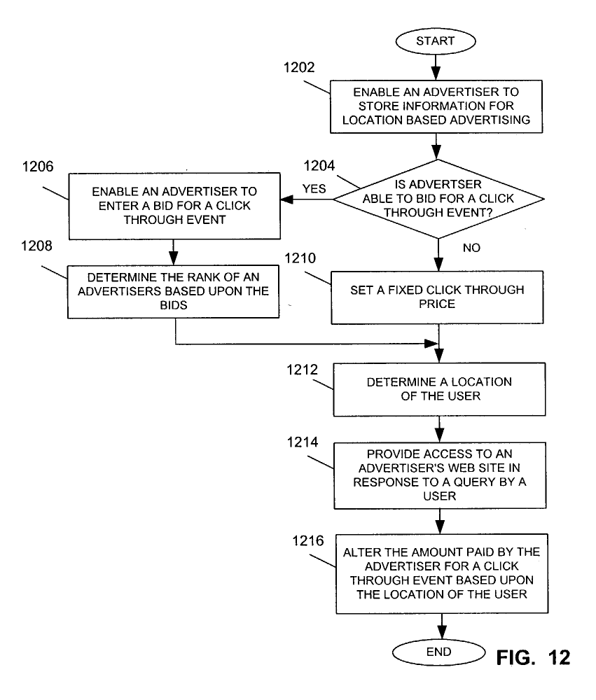

Turning now to FIG. 12, a flow chart shows a method of altering a payment established in an auction based upon a location of a user according to the present invention. In particular, an advertiser is able to store information for location based advertising at a step 1202. It is then determined whether the advertiser is able to bid for a click through event at a step 1204. If so, the advertiser is able to enter a bid for a click through at a step 1206. The rank of various advertisers bidding for click through events are then determined at a step 1208. If the advertiser is not allowed to bid for a click through event, a fixed click through price is set at a step 1210.

The location of the user is then determined at a step 1212. Access is then provided to the advertiser's web site in response to a search by a step 1214. Finally, the amount paid by the advertiser for a click through event is then altered based upon the location of the user at a step 1216. The amount paid by the advertiser can be reduced based upon the location of the user. For example, because certain users in certain locations, such as those locations shown in FIG. 6, may be more or less likely to result in a transaction, it may be beneficial to reduce the amount paid for click throughs by users in areas less likely to result in a transaction.

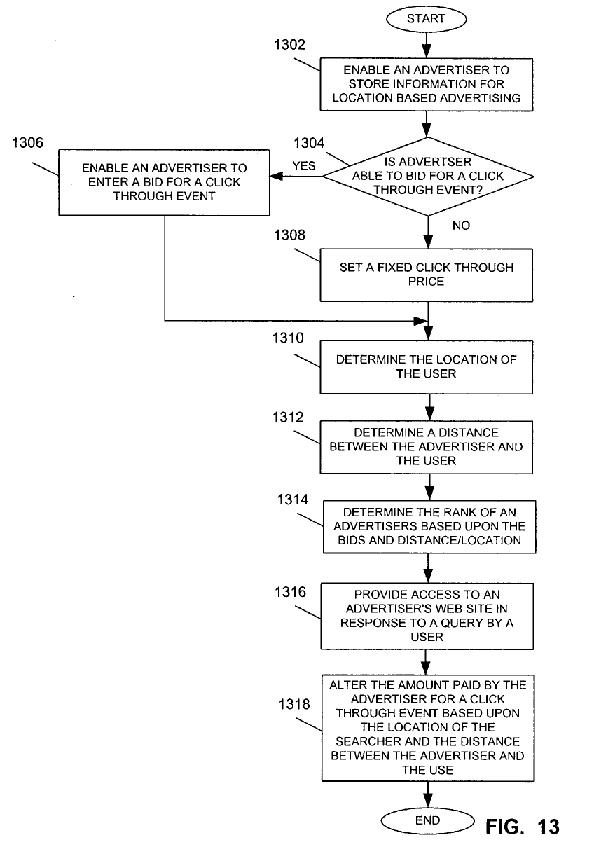

Turning now to FIG. 13, a flow chart shows a method of determining rank and altering payment established in an auction based upon distance and/or geographic location according to the present invention. In particular, an advertiser is able to store information for location based advertising at a step 1302. It is then determine whether the advertiser is able to bid for a click through event at a step 1304. If so, the advertiser is able to enter a bid for a click through at a step 1306. If the advertiser is not allowed to bid for a click through event, a fixed click through price is set at a step 1308. The location of the user is then determined at a step 1310. A distance between the advertiser and the user is then determined at a step 1312. The rank of various advertisers bidding for click through events is then determined at a step 1314. Access is then provided to the advertiser's web site in response to a search at a step 1316. Finally, the amount paid by the advertiser for a click through event is then altered based upon the determined location and distance between the advertiser and the user at a step 1318. Although the amount paid by a user is generally described as decreasing, the amount paid by an advertiser could increase as the distance between the advertiser and the user decreases. It is contemplated that the amount of increase would be set in the preferences by the user. For example, an advertiser may desire to pay a ten percent premium if a user within a certain range of the advertiser clicks through.

It can therefore be appreciated that the new and novel method of generating a search result list has been described. It will be appreciated by those skilled in the art that, given the teaching herein, numerous alternatives and equivalents will be seen to exist which incorporate the disclosed invention. As a result, the invention is not to be limited by the foregoing embodiments, but only by the following claims.

1. A method of generating a search result list, said method comprising the steps of:
enabling a click through by a user to a website of said advertiser;
determining the location of said user; and
modifying the price paid by said advertiser for receiving said click through based upon said location of said user.

2. The method of generating a search result list of claim 1 wherein said step of determining the location of user comprises determining the geographic distance between said user and a retail outlet of said advertiser.

3. The method of generating a search result list of claim 1 wherein said step of modifying the price paid by said advertiser comprises modifying the price paid by said advertiser based upon the location of said advertiser.

4. The method of generating a search result list of claim 1 wherein said step of modifying the price paid by said advertiser comprises modifying the price paid by said advertiser based upon said location of said user and a distance between said user and said advertiser.

5. The method of generating a search result list of claim 1 wherein said step of modifying the price paid by said advertiser comprises reducing the price paid by said advertiser.

6. The method of generating a search result list of claim 1 wherein said step of modifying the price paid by said advertisers comprises increasing the price paid by said advertiser.

7. A method of generating a search result list, said method comprising the steps of:
receiving a query for information from a user;
providing a link to a website of at least one advertiser in response to said query;
determining the distance between said user and a retail outlet of said advertiser; and
modifying the price paid by a advertiser for receiving a click through based upon the distance between said user and said advertiser.

8. The method of generating a search result list of claim 6 further comprising a step of providing an ordered list of websites of said advertisers based upon at least the distances from said user to said advertisers.

9. The method of generating a search result list of claim 6 further comprising a step of determining the location of said user.

10. The method of generating a search result list of claim 9 wherein said step of modifying the price paid by said advertiser comprises modifying the price paid by a advertiser based upon a combination of the location of said user and the distance between said user and said advertiser.

11. A method of generating a search result list, said method comprising the steps of:
enabling a plurality of advertisers to bid for a placement in a search result;
receiving a query for information from a user;
providing an order list of links to websites of said plurality of advertisers in said search result in response to said query;
determining the distance from said user to a retail outlet of said advertiser; and
reducing the price paid by said selected advertiser for said click through based upon the distance between said user and said advertiser.

12. The method of generating a search result list of claim 1 wherein said step of providing an order list of links to websites of said plurality of advertisers in response to said query comprises determining the order of said ordered list based upon at least the bids of said plurality of advertisers.

13. The method of generating a search result list of claim 12 wherein said step of determining the order of said ordered list based upon the bids of said plurality of advertisers further comprises determining the order of said order list based upon at least the distances between said user and said advertisers.

14. The method of generating a search result list of claim 12 wherein said step of determining the order of said ordered list based upon the bids of said plurality of advertisers further comprises determining the order of said list based upon at least the location of said user.

15. The method of generating a search result list of claim 11 wherein said step of providing an order list of links to websites of said plurality of advertisers in response to said query further comprises determining the order of said ordered list based upon at least the location of said user and the distance between said user and said advertisers.

16. A method of generating a search result list, said method comprising the steps of:
enabling a plurality of advertisers to bid for a placement in a search result;
receiving a query for information from a user;
determining a location of said user;
providing an ordered list of links to websites of said plurality of advertisers in said search result in response to said query;
determining the distance from said user to a retail outlet of said advertiser in response to a click through to a website of a selected advertiser; and
reducing the price paid by said selected advertiser for said click through based upon at least the distance between said user and said advertiser.

17. The method of generating a search result list of claim 16 wherein said step of providing an order list of links to websites of said plurality of advertisers in response to said query comprises determining the order of said ordered list based upon at least the bids of said plurality of advertisers.

18. The method of generating a search result list of claim 17 wherein said step of determining the order of said ordered list based upon the bids of said plurality of advertisers further comprises determining the order of said order list based upon at least the distances between said user and said advertisers.

19. The method of generating a search result list of claim 17 wherein said step of determining the order of said ordered list based upon the bids of said plurality of advertisers further comprises determining the order of said list based upon at least the location of said user.

20. The method of generating a search result list of claim 16 wherein said step of providing an order list of links to websites of said plurality of advertisers in response to said query further comprises determining the order of said ordered list based upon at least the location of said user and the distance between said user and said advertisers.

21. The method of generating a search result list of claim 16 wherein said step of reducing the price paid by said advertiser comprises reducing the price paid by a advertiser based upon at least a combination of the location of said user and the distance between said user and said advertiser.

22. A method of generating a search result list for receiving a click through from a user to a website of said advertiser, said method comprising the steps of:
receiving a keyword for a search from said user;
receiving a desired location for advertisers from said user;
enabling a click through by said user to said website of said advertiser; and
modifying the price paid by said advertiser for receiving said click through based upon at least said location of said user.

23. The method of generating a search result list of claim 22 wherein said step of receiving a desired location of advertisers discovered in said search comprises receiving location information data from a group consisting of one or more of:
an address;
a zip code;
a portion of a telephone number;
a landmark code; and
longitude and latitude.

24. The method of generating a search result list of claim 22 further comprising a step of receiving location information related to at least one retail location associated with said advertiser.

25. The method of generating a search result list of claim 22 wherein said step of modifying the price paid by said advertiser comprises modifying the price paid by said advertiser based upon at least a distance between said desired location of said advertisers and the location of said at least one retail location associated with said advertiser.

26. The method of generating a search result list of claim 22 wherein said step of modifying the price paid by said advertiser comprises reducing the price paid by said advertiser.

27. The method of generating a search result list of claim 22 wherein said step of modifying the price paid by said advertiser comprises increasing the price paid by said advertiser.

28. A method of generating a search result list, said method comprising the steps of:
receiving location information related to at least one retail location associated with said advertiser;
enabling a click through by a user to said website of said advertiser;
determining the distance between said user and said at least one retail location associated with said advertiser; and
modifying the price paid by said advertiser for receiving said click through based upon at least said distance between said user and said at least one retail location associated with said advertiser.

29. The method of generating a search result list of claim 28 wherein said step of receiving location information related to at least one retail location associated with said advertiser comprises receiving information data from a group consisting of one or more of:
an address;
a zip code;
a portion of a telephone number;
a landmark code; and
longitude and latitude.

30. The method of generating a search result list of claim 28 wherein said step of modifying the price paid by said advertiser comprises modifying the price paid by said advertiser based upon at least a distance between said user and said at least one retail location associated with said advertiser.

31. The method of generating a search result list of claim 28 further comprising a step of receiving a desired location for advertisers from said user.

32. The method of modifying the price paid by a advertiser of claim 31 wherein said step of modifying the price paid by said advertiser comprises modifying the price paid by said advertiser based upon a distance between a desired location for advertisers and the location of said at least one retail location associated with said advertiser.

33. A method of generating a search result list, said method comprising the steps of:
determining the location of a user;
determining the rank of said advertiser in said internet search result based upon said location of said user; and
enabling a click through by said user to said website of said advertiser;

34. The method of generating a search result list of claim 33 wherein said step of determining the location of user comprises determining the geographic distance between a user and a retail outlet of said advertiser.

35. The method of generating a search result list of claim 33 further comprising a step of modifying the price paid by said advertiser based upon at least the location of said advertiser.

36. The method of generating a search result list of claim 35 wherein said step of modifying the price paid by said advertiser comprises modifying the price paid by said advertiser based upon at least said location of said user and a distance between said user and said advertiser.

37. A system for generating a search result list, said system comprising:
a server receiving a click through by a user to a website of an advertiser in an auction based internet search, said server determining the distance between said user and said advertiser;
a database having stored therein a plurality of search listings, each listing being associated with an information provider, at least one keyword, a money amount, and a computer network location; and
a modified price paid by said advertiser based upon at least said distance between said user and said advertiser.

38. The system for generating a search result list of claim 37 wherein said distance comprises the geographic distance between said user and a retail outlet of said advertiser.

39. The system for generating a search result list of claim 37 wherein said distance is determined by a location entered by said user.

40. The system for generating a search result list of claim 37 wherein said distance is determined by a location of a retail outlet provided by said advertiser.

41. The system for generating a search result list of claim 37 wherein said location is determined by a region occupied by said user.

42. The system for generating a search result list of claim 37 wherein said modified price comprises a reduction in the price paid by said advertiser based upon at least the location of said user.

43. The system for generating a search result list of claim 37 wherein said modified price comprises an increase in a price paid by said advertiser based upon at least the location of said user.

44. The system for generating a search result list of claim 37 wherein said modified price paid by said advertiser comprises a modified price paid by said advertiser based upon at least the location of said user and the distance between said user and said advertiser.

45. The system for altering an internet search result of claim 37 further comprising an ordered list, of websites of said advertisers provided to said user.

46. The system for altering an internet search result of claim 45 wherein said ordered list of websites is based at least upon a plurality of bids for a click through based upon a search term.
